(19) United States
(12) Patent Application Publication
(10) Pub. No.: US 2026/0348587 A1
(43) Pub. Date: Nov. 5, 2026

(54) METHOD AND APPARATUS FOR IGNITION AND COMBUSTION STABILIZATION IN CAVITY-BASED HYPERSONIC PROPULSION ENGINE

(71) Applicant: University of Notre Dame du Lac, South Bend, IN (US)

(72) Inventor: Sergey B. Leonov, South Bend, IN (US)

(21) Appl. No.: 19/464,355

(22) Filed: Jan. 29, 2026

Related U.S. Application Data
(60) Provisional application No. 63/768,700, filed on Mar. 7, 2025.

(51) Int. Cl. F23R 3/18; F02C 7/266; F23R 3/00

(52) U.S. Cl. CPC F23R 3/18; F02C 7/266; F23R 3/007; F05D 2260/99

(57) ABSTRACT

A device may include a sidewall at least partially defining a flowpath through a cavity-based hypersonic engine. A device may include a cavity within the sidewall and adjacent the flowpath. A device may include a ceramic insert positioned within the cavity, the ceramic insert including: a powered electrode, and a grounded electrode, where the powered electrode and the grounded electrode are configured to cooperatively ignite an air/fuel mixture flowing along the flowpath.

### CROSS-REFERENCE TO RELATED APPLICATION(S)

This application claims priority to U.S. Provisional Patent Application No. 63/768,700, filed on Mar. 7, 2025, the entire contents of which are fully incorporated herein by reference.

### FIELD OF INVENTION

The present disclosure relates to methods and devices for obtaining and maintaining stable supersonic combustion, and more particularly to ignition and combustion stabilization in a cavity-based hypersonic engine.

### BACKGROUND

Despite long-term efforts, there remains a need for a solution to the problem of maintaining stable supersonic combustion under unfavorable conditions. To achieve stable supersonic combustion, processes, such as fuel mixing, ignition, flameholding, combustion completeness, and stability, must be maintained across a wide range of conditions.

Conventional methods of ignition and flameholding are the application of mechanical components such as wall cavities or steps, which increase the air-fuel residence time due to the presence of a flow separation zone. Flame stability in cavities is well-studied in common configurations and is quantified using a criteria of flame stability is called the Ozawa loop. The Ozawa criteria indicates the flow and fuel injection parameters favorable for stable flame existence.

Another factor limiting flameholding in a cavity-based combustor is the fuel mixing and into-the-cavity entrainment rate when using upstream injection of fuel. Through experimentation, the inventors have achieved effective control of the cavity flowfield and mixing to achieve flameholding improvement. The novel alternative approach described herein is an application of electrical or laser discharges for mixing enhancement and ignition.

### SUMMARY

This summary is provided to introduce a selection of concepts in a simplified form that are further described below in the detailed description. This summary is not intended to identify key features or essential features of the claimed subject matter.

In some aspects, which may be combinable with any other aspect, an apparatus for ignition and combustion stabilization in a cavity-based hypersonic engine having an inlet incudes a sidewall at least partially defining a flowpath through the cavity-based hypersonic engine, a cavity within the sidewall and adjacent the flowpath, and a ceramic insert positioned within the cavity, the ceramic insert including: a powered electrode, and a grounded electrode, where the powered electrode and the grounded electrode are configured to cooperatively ignite an air/fuel mixture flowing along the flowpath, where the cavity is at least partially defined by a first wall and a second wall, the first wall being positioned nearer the inlet than is the second wall, and where the ceramic insert is positioned adjacent the first wall.

In some aspects, which may be combinable with any other aspect, a wall of the ceramic insert at least partially defining the flowpath extends coplanar with the sidewall, and the powered electrode and grounded electrode are located on the wall of the ceramic insert.

In some aspects, which may be combinable with any other aspect, the first wall extends perpendicular to the sidewall, and the ceramic insert terminates along a plane parallel to the first wall.

In some aspects, which may be combinable with any other aspect, a third wall connects the first wall and the second wall, the third wall also at least partially defining the cavity, and the ceramic insert is positioned adjacent the third wall.

In some aspects, which may be combinable with any other aspect, the third wall extends generally perpendicularly relative to the first wall, and the second wall is inclined relative to the third wall.

In some aspects, which may be combinable with any other aspect, along the flowpath, the apparatus includes first fuel ports positioned in the sidewall and upstream relative to the ceramic insert.

In some aspects, which may be combinable with any other aspect, the apparatus includes second fuel ports positioned in the third wall.

In some aspects, which may be combinable with any other aspect, along the flowpath, the powered electrode is located inline with an upper side of the grounded electrode.

In some aspects, which may be combinable with any other aspect, along the flowpath, the powered electrode is located upstream from the grounded electrode.

In some aspects, which may be combinable with any other aspect, the grounded electrode is a bar, and the bar extends along the flowpath and terminates with an end of the ceramic insert along the flowpath.

In some aspects, which may be combinable with any other aspect, the bar extends along the flowpath at least 50% of a length of the ceramic insert along the flowpath.

In some aspects, which may be combinable with any other aspect, the powered electrode is one of three powered electrodes, the bar is one of two bars, and the three powered electrodes are spaced apart on the ceramic insert along a direction perpendicular to the flowpath.

In some aspects, which may be combinable with any other aspect, each bar is located between an adjacent pair of the three powered electrodes.

In some aspects, which may be combinable with any other aspect, the powered electrode is a plasma electrode.

In some aspects, which may be combinable with any other aspect, the powered electrode is grounded or under a controlled voltage.

In some aspects, which may be combinable with any other aspect, a cavity-based hypersonic engine includes: the inlet, a diffuser, the apparatus, and an exhaust, and, along the flowpath, the engine is configured such that air enters the inlet, passes through the diffuser, is mixed with fuel and combusts within the apparatus, and flows out of the engine through the exhaust.

In some aspects, which may be combinable with any other aspect, the fuel is a gaseous or evaporated fuel including at least one of hydrogen, ethylene, and methane.

In some aspects, which may be combinable with any other aspect, a controller is configured to supply voltage to the powered electrode to selectively create plasma via the powered electrode and the grounded electrode.

In some aspects, which may be combinable with any other aspect, in operation, the controller is configured to supply voltage to the powered electrode to ignite the fuel to selectively create bulk plasma.

In some aspects, which may be combinable with any other aspect, after the controller ceases supplying voltage to the powered electrode, at least a portion of the bulk plasma forms a combustion flame that is retained within the cavity.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a cavity-based hypersonic engine.

FIG. 2 illustrates another view of the engine of FIG. 1.

FIG. 3 illustrates a bottom-up sectional view of an extended flowpath of the cavity-based hypersonic engine of FIG. 1.

FIG. 4 illustrates a side sectional view of the extended flowpath of the cavity-based hypersonic engine of FIG. 3.

FIG. 5A illustrates an image of plasma generation within the engine of FIG. 1 at a first time interval.

FIG. 5B illustrates an image of plasma generation within the engine of FIG. 1 at a second time interval.

FIG. 5C illustrates an image of plasma generation within the engine of FIG. 1 at a third time interval.

FIG. 6A illustrates the engine of FIG. 1 in a bulk combustion mode.

FIG. 6B illustrates the engine of FIG. 1 in a bulk combustion mode.

FIG. 6C illustrates the engine of FIG. 1 in a shear combustion mode.

FIG. 6D illustrates the engine of FIG. 1 in a cavity combustion mode.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Unless otherwise defined, all technical and scientific terms used herein have the same meaning as commonly understood by one of ordinary skill in the art. In case of conflict, the present disclosure, including definitions, will control. Exemplary methods and materials are described below, although methods and materials similar or equivalent to those described herein can be used in practice or testing of the embodiments and aspects described herein.

As used herein, terms such as “include,” “including,” “contain,” “containing,” “having,” and the like mean “comprising.” The present disclosure also contemplates other embodiments “comprising,” “consisting essentially of,” and “consisting of” the embodiments or elements presented herein, whether explicitly set forth or not. As used herein, “comprising,” is an “open-ended” term that does not exclude additional, unrecited elements or method steps. As used herein, “consisting essentially of” limits the scope of a claim to the specified materials or steps and those that do not materially affect the basic and novel characteristics of the claimed invention. As used herein, “consisting of” excludes any element, step, or ingredient not specified in the claim.

As used herein, the term “a,” “an,” “the” and similar terms used in the context of the disclosure (especially in the context of the claims) are to be construed to cover both the singular and plural unless otherwise indicated herein or clearly contradicted by the context. In addition, “a,” “an,” or “the” means “one or more” unless otherwise specified.

As used herein, the term “or” can be conjunctive or disjunctive.

As used herein, the term “and/or” refers to both the conjunctive and disjunctive.

As used herein, the term “substantially” means to a great or significant extent, but not completely.

As used herein, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In one aspect, the term “about” refers to any values, including both integers and fractional components that are within a variation of up to ±10% of the value modified by the term “about.” Alternatively, “about” can mean within 3 or more standard deviations, per the practice in the art. Alternatively, such as with respect to biological systems or processes, the term “about” can mean within an order of magnitude, in some embodiments within 5-fold, and in some embodiments within 2-fold, of a value. As used herein, the symbol “~” means “about” or “approximately.”

All ranges disclosed herein include both end points as discrete values as well as all integers and fractions specified within the range. For example, a range of 0.1-2.0 includes 0.1, 0.2, 0.3, 0.4 . . . 2.0. If the end points are modified by the term “about,” the range specified is expanded by a variation of up to ±10% of any value within the range or within 3 or more standard deviations, including the end points, or as described above in the definition of “about.”

In the examples disclosed herein, plasma is generated as part of a propulsion system for a hypersonic-capable engine. The plasmas effect is generated through strong localized heating and the generation of non-equilibrium species that promote chemical reactions. However, the technical realization of plasma-based flameholding in the propulsion system is challenging in harsh environments with limited electrical power, which are typical for applications for such a motor, e.g., scramjets. Power consumption may be minimized through the use of non-uniform distributions and pulse-periodic operation. In such “smart” systems, the plasma location is self-sustained with the flow structure, controlled with the proper geometry or by beamed energy deposition, which may represent a relatively complex design. The self organization of plasma filaments was recently demonstrated with the Plasma-Injection Modules (PIMs, S. Leonov, Plasma Injection Modules, Patent No. U.S. Pat. No. 12,173,902 B2, Dec. 24, 2024, Applicant: University of Notre Dame du Lac, Inventor: Sergey B. Leonov, application Ser. No. 18/347,075, incorporated herein by reference) under conditions of direct fuel injection from the combustor wall. The structures and concepts of the present application build on these concepts. Because of a strong coupling of the flow and plasma, the plasma filaments are elongated far from the fuel injection port following the fuel plume. This technique exhibits fuel mixing and ignition authority across a wide range of flow parameters without mechanical flameholders installed in a flowfield.

Electrical discharges control cavity flow and fuel-air mixing. These effects may be realized through increasing the pressure in the cavity due to plasma heating, excitation of the flow oscillations, or, in general, by a modification of the cavity shear layer. The underlying concept as disclosed herein is to utilize a longitudinal plasma generated in front of the cavity to control the flow pattern and the pressure distribution over the cavity. For this purpose, the electrode system (i.e., the ceramic insert, the powered electrode, the grounded electrode, and their associated geometries as disclosed herein) is designed to provide multiple plasma filaments originating behind the fuel injection ports and terminating in the cavity. The relatively hot subsonic plasma channels allow equalization of the pressure in the cavity and upstream area. The hot subsonic plasma channels also introduce local superheated zones with a high level of air/fuel high rate of air/fuel chemical reactions, including molecular dissociation, dissociation both in the free stream and in the cavity, providing local zones of fuel (highly reactive mixture with the potential for fast ignition) with the potential for ignition. This is the basis for the plasma-based flameholding concepts, which may also be referred to as combustion stabilization concepts, disclosed herein. In other examples, laser discharges are used instead of electrical discharges to achieve similar results.

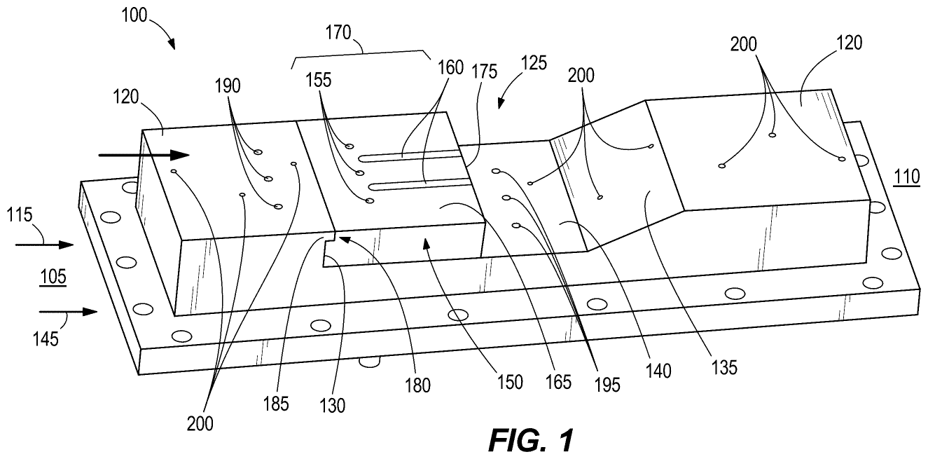

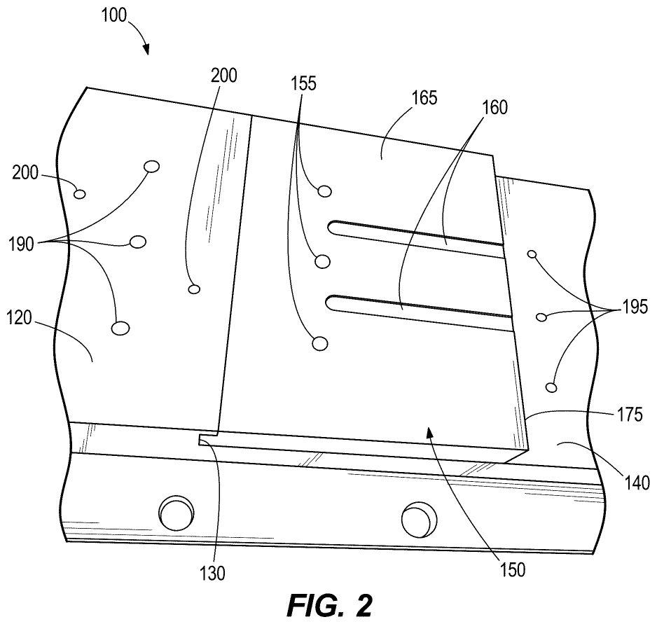

FIGS. 1 and 2 illustrates an apparatus 100, i.e., an engine for a cavity-based hypersonic engine, having an inlet 105 and an outlet 110, and a flowpath 115 extends from the inlet 105 to the outlet 110. The apparatus includes a sidewall 120 that at least partially defines the flowpath 115. The apparatus further includes a cavity 125 within the sidewall 120 and adjacent the flowpath 115. The cavity 125 is defined at least by a first wall 130, a second wall 135, and a third wall 140. The first wall 130 is positioned closer to the inlet 105 (i.e., upstream along the flowpath 115, which also defines a flow direction 145) than the second wall 135 and the third wall 140 are positioned relative to the inlet 105. The first wall 130 extends substantially perpendicularly to the flow direction 145, and the third wall 140 extends generally parallel to the flow direction 145. The third wall 140 connects the first wall 130 and the second wall 135, and the second wall 135 is inclined relative to the third wall 140. Stated otherwise, the second wall 135 is not parallel to either of the first wall 130 or the third wall 140.

The cavity 125 includes a ceramic insert 150 and adjacent the flowpath 115. The ceramic insert includes at least one powered electrode 155 and at least one grounded electrode 160. In some examples, more powered electrodes 155 and grounded electrodes 160 are provided, e.g., two, four or six of each of the powered electrodes 155 and grounded electrodes 160. In some examples, a different number of powered electrodes 155 and grounded electrodes 160 are provided. The powered electrode 155 can be a plasma electrode and can be activated under a controlled voltage. In the embodiment disclosed herein, the ceramic insert 150 includes three powered electrodes 155 and two grounded electrodes 160. The powered electrodes 155 and the grounded electrodes 160 cooperatively ignite an air/fuel mixture flowing along the flowpath 115. In this example, the three powered electrodes 155 are spaced apart on the ceramic insert 150 along a direction perpendicular to the flow direction 145. Further, each grounded electrode 160 positioned between an adjacent pair of the three powered electrodes 160. In other words, the powered electrodes 155 and grounded electrodes 160 are alternately spaced across the top surface 165 of the ceramic insert 150. In some examples, each of the powered electrodes 155 is located inline along the flow direction 145 with an upper side of a respective one of the grounded electrodes 160. In other examples, each of the powered electrodes 155 is located inline with each of the grounded electrodes 160 perpendicular to the flow direction 145 (i.e., inline spanwise across the ceramic insert 175). In some examples, the powered electrodes 155 and the grounded electrodes 160 protrude into the flow. In other examples, the powered electrodes 155 and the grounded electrodes 160 are flush with the sidewall 120 and the ceramic insert 150.

The ceramic insert 150 is positioned adjacent the first wall 130, and as shown in FIGS. 1 and 2, abuts the first wall 130. The ceramic insert 150 thus is positioned in the front of the cavity 125 along the flowpath 115. Further, the ceramic insert 150 at least partially defines the flowpath 115 and, in this example, extends coplanar with the sidewall 120 such that a top surface 165 of the ceramic insert 150 is flush with the sidewall 120. The powered electrode 155 and grounded electrode 160 are located on the top surface 165 of the ceramic insert 150.

The ceramic insert 150 is likewise adjacent to and abuts at least a portion of the third wall 140. In this example, the ceramic insert 150 abuts the third wall 140 along an entire length 170 of the ceramic insert 150, and terminates along a plane (e.g., an end 175 of the ceramic insert 150) parallel to the first wall 130. In some examples, like the example shown in FIGS. 1 and 2, the ceramic insert includes a notch 180 and the first wall 130 includes a corresponding protrusion 185 that is received within the notch 180. The notch 180 and protrusion 185 serve to better retain the ceramic insert 150 against the first wall 130 in operation of the apparatus 100.

With continued reference to the ceramic insert 150, the powered electrodes 155 are located upstream from the grounded electrodes 160 along the flow direction 145. In other words, the powered electrodes 155 are closer to the inlet 105 than the grounded electrodes 160. Further, the grounded electrodes 160 are, in some examples, in the form of bars. Thus, the grounded electrodes 160 can be oriented to extend along the flow direction 145 significantly farther than the grounded electrodes 160. Further, the grounded electrodes 160 terminate at the end 175 of the ceramic insert 150. In some examples, the grounded electrode 160 extends along the flow direction 145 at least 50% of the length 170 of the ceramic insert 150 along the flow direction 145.

The apparatus 100 further includes fuel ports 190, 195 for injecting fuel into the flowpath 115. In some examples, the fuel is ethylene. In other examples, the fuel is a gaseous or evaporated fuel, such as hydrogen, ethylene, methane, others or combinations of fuels. In this context, evaporated means the transformation of liquid fuel into a gaseous phase. However, the fuel may be further transformed when passing through the plasma state, e.g., into a mixture of components that are the products of evaporation and cracking (erase) of heavy molecules. The fuel ports 190, 195 can include upstream fuel ports 190 and cavity fuel ports 195. The upstream fuel ports 190 are positioned in a portion of the sidewall 120 that is upstream of (i.e., relatively closer to the inlet 105 than) the ceramic insert 150. The upstream fuel ports 190 are spaced apart perpendicularly to the flow direction 145 at a common distance from the ceramic insert 150. The cavity fuel ports 195 are positioned within the third wall 140 and are also spaced apart perpendicularly to the flow direction 145 at a common distance from the ceramic insert 150. In this example, the apparatus includes three upstream fuel ports 190 and three cavity fuel ports 195. The apparatus also includes pressure sensors and/or pressure taps 200 in at least one of the sidewall 120, the second wall 135, and the third wall 140. In the example shown in FIGS. 1 and 2, the sidewall 120, the second wall 135, and the third wall 140 all include the pressure sensors and/or pressure taps 200.

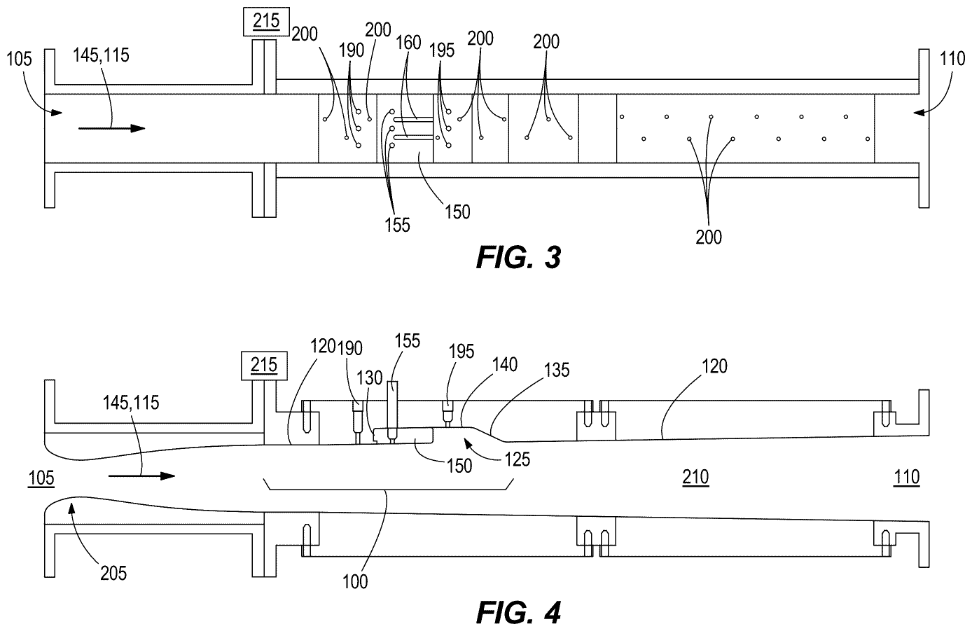

Referring now to FIGS. 3 and 4, an extended flowpath 115 of the cavity-based hypersonic engine is illustrated and includes the apparatus 100 installed therein. The extended flowpath 115 includes the inlet 105, a diffuser 205 upstream of the apparatus 100 (i.e., between the inlet 105 and the apparatus 100), and an extended exhaust 210 leading to the outlet 110.

In some aspects, the techniques described herein relate to a cavity-based hypersonic engine including: the inlet 105, the diffuser 205, the apparatus 100, and the exhaust 210, wherein, along the flow direction 145, the engine is configured such that air enters the inlet 105, passes through the diffuser 205, is mixed with fuel and combusts within the apparatus 100, and flows out of the engine through the exhaust 210. A controller 215 is operatively connected to the apparatus 100, and controls supply voltage to the powered electrode 155, and fuel injection through the upstream fuel ports 190 and cavity fuel ports 195. The controller 215 supplies voltage to the powered electrode 155 to selectively create plasma via the powered electrode 155 and the grounded electrode 160, and more specifically to create plasma by igniting the fuel by ignition via an arc from the powered electrode 155 to the grounded electrode 160. In some examples, the fuel is ignited to create bulk plasma.

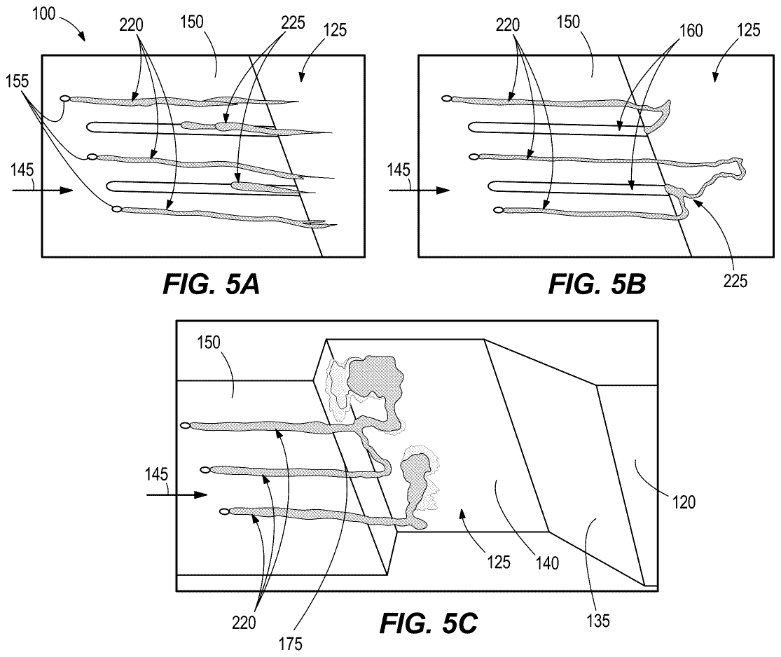

FIGS. 5A-5C illustrate an example of plasma 220 development over time using the apparatus 100. As shown in FIG. 5A, as the powered electrodes 155 are activated, cathode spots 225 are produced that move with the flow direction 145 (airflow through the apparatus 100 has already occurred) toward the end 175 of the ceramic insert 150. Fuel injection through the upstream fuel ports 190 and cavity fuel ports 195 occurs at about the same time as the powered electrodes 155 are activated. The image in FIG. 5A is taken at about 0.2 ms or less after the powered electrodes 155 are activated. In FIG. 5B, the cathode spots 225 reach the end of the grounded electrode 160, which is in the form of a bar that terminates with the end 175 of the ceramic insert 150. The image in FIG. 5B is taken at about 1 ms after the powered electrodes 155 are activated. FIG. 5C illustrates a third image at about 20 ms after the powered electrodes 155 are activated and illustrates the plasma 220 connected to the third wall 140 at the locations of the cavity fuel ports 195 (obscured in FIG. 5C by the plasma 220). This typically occurs at generally lower pressures (e.g., below 3 bar and 400K), while plasma connection to the grounded electrodes 160 alone (e.g., not to the cavity fuel ports 195) occurs at higher pressures (e.g., above 3 bar and 400K).

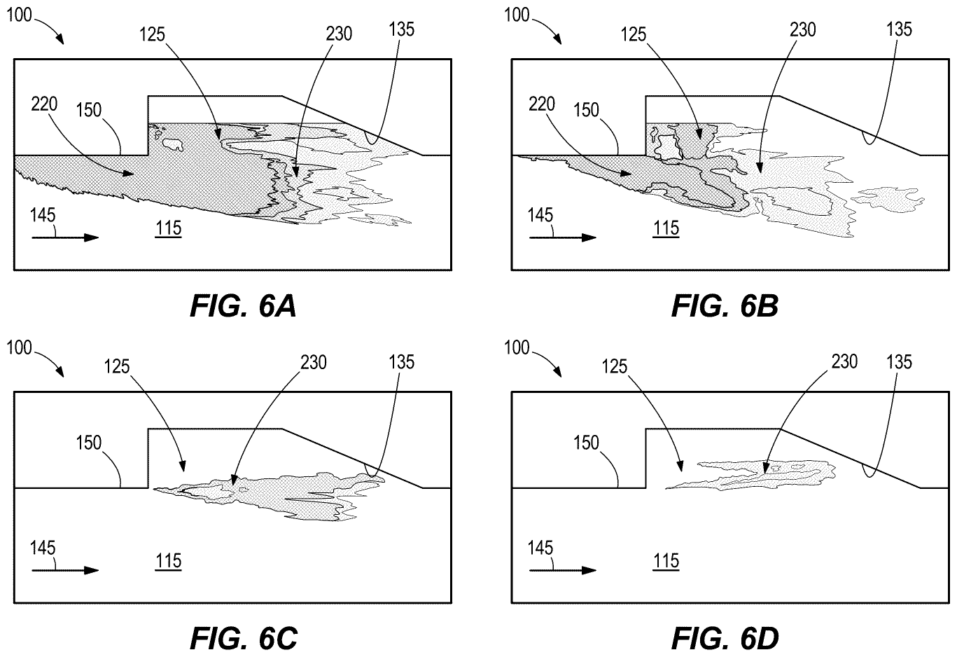

Referring now to FIGS. 6A-6D, a cross section of the apparatus 100 is illustrated. Of particular note, the bottom-most portion of the cavity 125 (i.e., where the cavity fuel ports 195 are located) is obscured at the point of data capture forming the basis of FIGS. 6A-6D. FIGS. 6A-6D illustrate the three types of combustion patterns created by the apparatus 100 when in use, i.e., (1) bulk combustion as shown in FIGS. 6A and 6B, (2) shear layer combustion as shown in FIG. 6C, and (3) in-cavity combustion as shown in FIG. 6D. Bulk combustion is characterized by in-core-flow flame location and a significant (e.g., more than two times) pressure increase in and behind the cavity 125. In FIG. 6A, the powered electrodes 155 are still activated and bulk plasma 220 is observed. FIG. 6B illustrates the same bulk plasma at about 50 μs after the powered electrodes 155 are deactivated. Thus, the bulk plasma 220 is retained within the cavity 125 after the controller 215 ceases supplying voltage to the powered electrodes 155. At this stage, the bulk plasma 220 can be referred to as a combustion flame.

The flow structure and flame remain as shown in FIG. 6A, i.e., when the powered electrodes 155 are activated, for about 100 μs due to the core flow speed and the geometry of the apparatus 100. A flame 230 is illustrated in all of FIGS. 6A-6D and is the result of the plasma 22 igniting the fuel. The flame 230 occupies a wedge-like zone, including the core flow (i.e., within the flowpath 115), shear layer (i.e., in a transition region between the flowpath 115 and the cavity 125), and the cavity 125. The shear layer combustion illustrated in FIGS. 6A-6C is largely observed for upstream fuel injection during plasma assistance, i.e., when the powered electrode 155 is activated. In particular, the bulk combustion mode is an “extended” form of shear layer combustion, in which the flameholding separation zone moves upstream toward the electrodes 155, 160. After the powered electrode 155 is deactivated, the shear layer combustion slowly degrades for about 1 ms to 2 ms, which is approximately one cavity cycling time at operating conditions of about 3 bar and 500K. During fuel injection from both the upstream fuel ports 190 and the cavity fuel ports 195, the shear layer flame may move to the cavity 125 or blow out after plasma is turned off. In the case of in-cavity 125 combustion shown in FIG. 6D, this may continue indefinitely or blow out in t=0.1 ms to 5 ms, depending on conditions.

A number of implementations have been described. Nevertheless, it will be understood that various modifications may be made without departing from the spirit and scope of the disclosure. Accordingly, other implementations are within the scope of the following claims.

1. An apparatus for ignition and combustion stabilization in a cavity-based hypersonic engine having an inlet, the apparatus comprising:
a sidewall at least partially defining a flowpath through the cavity-based hypersonic engine,
a cavity within the sidewall and adjacent the flowpath, and
a ceramic insert positioned within the cavity, the ceramic insert including:
a powered electrode, and
a grounded electrode,
wherein the powered electrode and the grounded electrode are configured to cooperatively ignite an air/fuel mixture flowing along the flowpath,
wherein the cavity is at least partially defined by a first wall and a second wall, the first wall being positioned nearer the inlet than is the second wall, and
wherein the ceramic insert is positioned adjacent the first wall.

2. The apparatus of claim 1, wherein a wall of the ceramic insert at least partially defining the flowpath extends coplanar with the sidewall, and
wherein the powered electrode and grounded electrode are located on the wall of the ceramic insert.

3. The apparatus of claim 2, wherein the first wall extends perpendicular to the sidewall, and
wherein the ceramic insert terminates along a plane parallel to the first wall.

4. The apparatus of claim 3, wherein a third wall connects the first wall and the second wall, the third wall also at least partially defining the cavity, and
wherein the ceramic insert is positioned adjacent the third wall.

5. The apparatus of claim 4, wherein the third wall extends generally perpendicularly relative to the first wall, and wherein the second wall is inclined relative to the third wall.

6. The apparatus of claim 5, wherein, along the flowpath, the apparatus includes first fuel ports positioned in the sidewall and upstream relative to the ceramic insert.

7. The apparatus of claim 6, wherein the apparatus includes second fuel ports positioned in the third wall.

8. The apparatus of claim 7, wherein, along the flowpath, the powered electrode is located inline with an upper side of the grounded electrode.

9. The apparatus of claim 1, wherein, along the flowpath, the powered electrode is located upstream from the grounded electrode.

10. The apparatus of claim 9, wherein the grounded electrode is a bar, and the bar extends along the flowpath and terminates with an end of the ceramic insert along the flowpath.

11. The apparatus of claim 10, wherein the bar extends along the flowpath at least 50% of a length of the ceramic insert along the flowpath.

12. The apparatus of claim 11, wherein powered electrode is one of three powered electrodes, wherein the bar is one of two bars, and wherein the three powered electrodes are spaced apart on the ceramic insert along a direction perpendicular to the flowpath.

13. The apparatus of claim 12, wherein each bar is located between an adjacent pair of the three powered electrodes.

14. The apparatus of claim 9, wherein the powered electrode is a plasma electrode.

15. The apparatus of claim 9, wherein the powered electrode is grounded or under a controlled voltage.

16. A cavity-based hypersonic engine comprising:
the inlet,
a diffuser,
the apparatus of claim 1, and
an exhaust,
wherein, along the flowpath, the engine is configured such that air enters the inlet, passes through the diffuser, is mixed with fuel and combusts within the apparatus, and flows out of the engine through the exhaust.

17. The cavity-based hypersonic engine of claim 16, wherein the fuel is a gaseous or evaporated fuel including at least one of hydrogen, ethylene, and methane.

18. The cavity-based hypersonic engine of claim 16, wherein a controller is configured to supply voltage to the powered electrode to selectively create plasma via the powered electrode and the grounded electrode.

19. The cavity-based hypersonic engine of claim 18, wherein, in operation, the controller is configured to supply voltage to the powered electrode to ignite the fuel to selectively create bulk plasma.

20. The cavity-based hypersonic engine of claim 19, wherein, after the controller ceases supplying voltage to the powered electrode, at least a portion of the bulk plasma is retained within the cavity.
